(19) United States
(12) Patent Application Publication
(10) Pub. No.: US 2016/0347017 A1
(43) Pub. Date: Dec. 1, 2016

(54) DEVICE FOR COMPACTING STACKED SHEETS OR PULP SLABS

(71) Applicant: ANDRITZ AG, Graz (AT)

(72) Inventor: Hubert Riemer, St. Oswald (AT)

(21) Appl. No.: 15/167,045

(22) Filed: May 27, 2016

(30) Foreign Application Priority Data
May 29, 2015 (AT) A 50440/2015

(51) Int. Cl. B30B 15/00; B30B 1/14; D21D 99/00; B30B 9/30

(52) U.S. Cl. CPC B30B 15/0029; B30B 9/301; B30B 1/14; D21D 99/00

(57) ABSTRACT

A device for compacting stacked sheets of chemical, mechanical, or recycled fibre pulp, or pulp slabs from a preceding slab press into preferably prism-shaped bales in a press, with a device for feeding the pulp to the press. It is primarily characterized in that a press unit is provided in the form of a mechanical toggle press. This can replace the commonly-use hydraulic system and greatly reduces the amount of maintenance required.

### BACKGROUND

The present invention relates to a device for compacting stacked sheets of chemical, mechanical, or recycled fibre pulp, or pulp slabs from a preceding slab press into preferably prism-shaped bales in a press.

The bale press is a unit in the baling line of a chemical/mechanical/recycled fibre pulp production line in the pulp and paper industry and is used in order to compact bales to a pre-set, constant height. The bales consist either of individual sheets that have been dried and stacked in a sheet drying plant, dried and pre-compacted fluff pulp from a flash drying plant, or pre-dewatered pulp from a wet lap plant. This type of bale press usually uses large hydraulic cylinders to apply the necessary pressing forces. Large amounts of hydraulic oil and large storage tanks for this oil are needed in this case. There is also a risk of contamination if there are any leaks. In addition, eccentric presses are known from U.S. Pat. No. 1,332,576, for example, in which the levers have a point of passage when extended, where neither the applied force nor the height of the finished product can be set because they are defined by the design of the press.

### SUMMARY

The object of the invention is to avoid the maintenance times and risk of contamination as far as possible.

The invention is disclosed as a press unit in the form of a mechanical toggle press. As a result, it is possible to achieve shorter cycle times, and thus higher production. In addition, the energy requirement can be reduced.

An advantageous embodiment of the invention is characterized in that the press unit is designed as a purely electro-mechanical system driven by a servomotor and gearbox. This can replace the hydraulic system and greatly reduces the amount of maintenance required.

A favorable embodiment of the invention is characterized in that the lengths of the levers in the toggle press can be adapted, where the eccentric of the toggle press can also be suitable for adaptation. With these design features, the force, speed, and acceleration progressions at the press ram can be adapted to the compression speed and the compression resistance during bale compacting to optimum effect.

It has also proved to be an advantage if a device for stroke adjustment is provided between the toggle press and the press ram. By adjusting the stroke, the maximum pressing force can always be applied in the final position of the toggle levers even if the individual slabs are different heights.

An advantageous embodiment of the invention is characterized in that a motor is provided to apply force, where it would also be possible as an alternative to provide a motor on either side or a toothed rod with a drive.

### BRIEF DESCRIPTION OF THE DRAWING

The invention will now be disclosed in examples and referring to the drawings, where

FIG. 1 shows a sectional view of the press according to the invention,

FIG. 2 shows a side view of the press according to FIG. 1, and

FIG. 3 shows a sectional view along the line marked III-III in FIG. 1.

### DETAILED DESCRIPTION

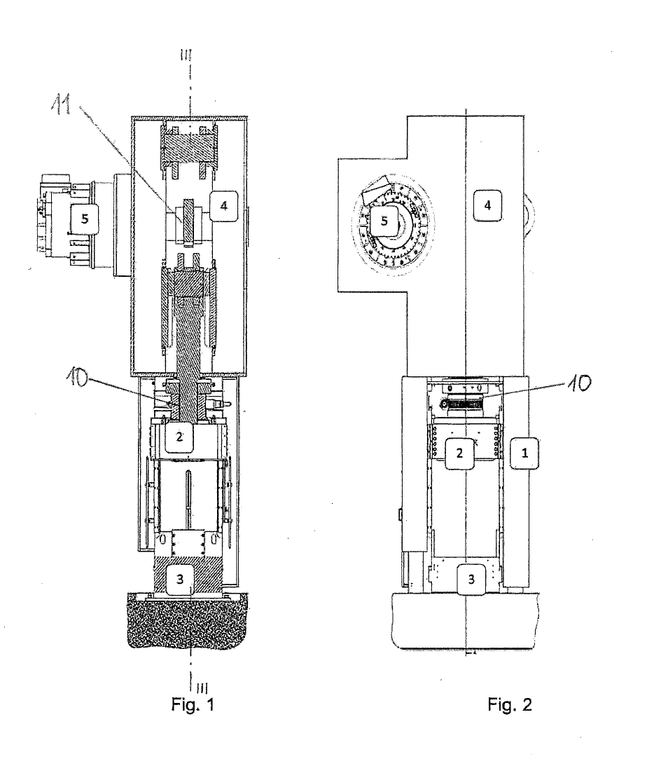

FIG. 1 shows a bale press according to the invention. The bales are fed to the bale press and placed on the press table by means of a belt conveyor. Here, the bales can consist of stacked sheets of chemical, mechanical, or recycled fibre pulp, or of pulp slabs from a preceding slab press. By pressing down the press ram 2, the bale is compacted to the pre-set height. The pressing forces between the press ram and the pressing table are absorbed by the press frame 1. According to the invention, the pressing force is applied by a toggle pressing system 4 actuated via a servomotor and a gearbox.

The main advantages of the toggle press are the levers, which can be controlled in such a way that the exact pressing force needed or the exact bale height required is achieved. There is no need to extend the levers fully in order to do this. After reaching the maximum pressing force or the desired height, the levers return to their starting position again and thus relieve the pressure on the pulp bale produced. Unlike eccentric presses, which do not reach their maximum force until the lowest point when the levers are disposed in a straight line, it is possible to regulate the height of the bale easily at the toggle press, meaning that variable bale heights can also be produced or a product changeover can be implemented very easily.

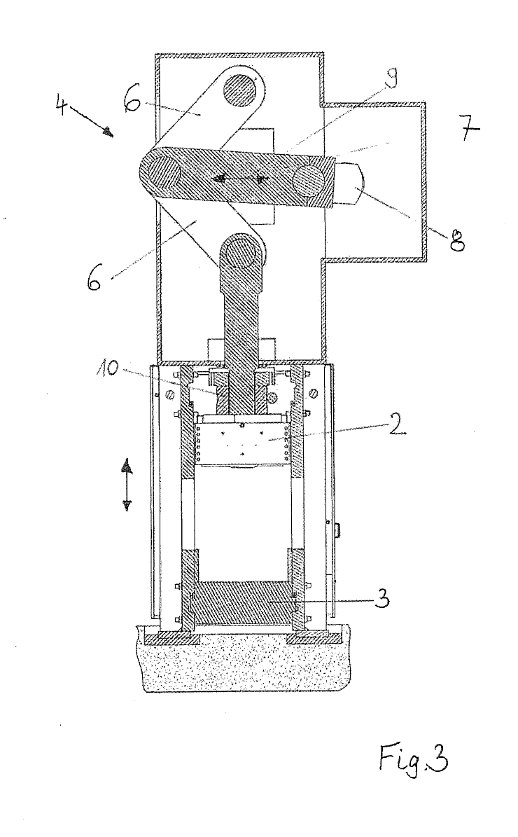

FIG. 2 shows a side view of the press according to the invention. The press frame 1, the press ram 2, and the pressing table 3 with belt conveyor are shown again here. The figure also shows the servo-drive 5 for the pressing unit 4, which is connected via a gearing to the lever 7 to allow the movement in direction of the arrow 9.

FIG. 3 shows a sectional view of the press along the line marked III-III in FIG. 1. In the lower part, the pressing table 3 and the belt conveyor are clearly visible. The press unit 4 consists of several levers 6 and 7, respectively. Due to the movement of the lever 7 along the slot 8 in the direction of the arrow 9, the other two levers are moved into a straight line above one another, which causes the press ram 2 to be moved in the direction of the arrow 10 and applies the maximum pressing force when the levers 6 are in the extended position. A stroke adjusting device 10 between the levers and the press ram 2 and which is built into the head of the press ram 2 will ensure that the maximum pressing force is applied to the pulp at all times, which is very important with different bale heights. In order to adapt the force progression, but also the speed and acceleration progressions to the compression resistance or adapt the compression speed during bale compacting, the length of the levers 6, 7 can be selected accordingly. This can also be achieved by modifying the eccentric disc 11. More generally, “adjusting” should be understood as adapting to a desired size, such as length, by either physically altering the component, modifying an intermediate component, or replacing the component with one of a different size.

The invention is not limited to the examples shown. For example, the press can be driven by servomotors mounted on both sides or by a driven, toothed rod.

1. Device for compacting stacked slabs or sheets of pulp with a press ram, comprising a mechanical toggle for advancing the press ram against the stacked slabs.

2. The device of claim 1, wherein the mechanical toggle is in a pressing unit and the pressing unit is a purely electro-mechanical system in which the mechanical toggle is driven by a servo motor and gearbox.

3. The device of claim 1, wherein the mechanical toggle includes a plurality of adjustable-length levers.

4. The device of claim 1, wherein the mechanical toggle includes an adjustable eccentric.

5. The device of claim 1, wherein the press ram has a pressing stroke and a stroke-adjustment device is provided between the mechanical toggle and the press ram.

6. The device of claim 2, wherein the mechanical toggle includes a plurality of adjustable-length levers.

7. The device of claim 2, wherein the mechanical toggle includes an adjustable eccentric.

8. The device of claim 2, wherein the press ram has a pressing stroke and a stroke-adjustment device is provided between the mechanical toggle and the press ram.

9. The device of claim 1, wherein the mechanical toggle includes an adjustable eccentric and the press ram has a pressing stroke and a stroke-adjustment device is provided between the mechanical toggle and the press ram.

10. The device of claim 3, wherein the press ram has a pressing stroke and a stroke-adjustment device is provided between the mechanical toggle and the press ram.

11. The device of claim 6, wherein the mechanical toggle includes an adjustable eccentric and the press ram has a pressing stroke and a stroke-adjustment device is provided between the mechanical toggle and the press ram.

12. The device of claim 1, wherein the device includes a press table and a conveyor for feeding pulp slabs from a preceding slab press unit onto the press table.

13. The device of claim 2, wherein the device includes a press table and a conveyor for feeding pulp slabs onto the press table.

14. The device of claim 1, wherein the mechanical toggle is in a pressing unit that includes a press mould which produces a prism-shaped bale when the press ram is advanced against the slabs.

15. The device of claim 1, wherein the mechanical toggle has lateral sides and one motor applies force on one lateral side of the toggle or a motor on each lateral side applies force to the toggle.

16. The device of claim 1, wherein a toothed rod with an operatively connected drive applies force to the mechanical toggle.
